(19) United States
(12) Patent Application Publication
(10) Pub. No.: US 2008/0087268 A1
(43) Pub. Date: Apr. 17, 2008

(54) Cooking bag for grill

(76) Inventor: Alan Burton, Lake Worth, FL (US)

Correspondence Address: Sunbeam Products, Inc., 2381 Executive Center Drive, Boca Raton, FL, 33431, US

(21) Appl. No.: 11/999,647

(22) Filed: Dec. 4, 2007

Related U.S. Application Data
(63) Continuation-in-part of application No. 11/602,907, filed on Nov. 20, 2006.
(60) Provisional application No. 60/749,077, filed on Dec. 9, 2005.

(51) Int. Cl. B65D 30/22; A23L 1/01; A47J 37/06

(52) U.S. Cl. 126/9 R; 383/39; 426/523

(57) ABSTRACT

A cooking bag for supporting a food item between top and bottom halves of a clam shell type grill. The cooking bag is positionable on a bottom cooking surface on the bottom half of the grill and included a support member for engaging the bottom half of the grill. The bag support member maintains the position of the bag on the bottom cooking surface of the grill.

### RELATED APPLICATION

This is a continuation in part (CIP) of U.S. patent application Ser. No. 11/602,907, filed Nov. 20, 2006, entitled Cooking Bag For Grill, which claims the benefit of U.S. Provisional Application Ser. No. 60/749,077, filed on Dec. 9, 2005, the specifications and drawings of which are herein incorporated by reference in their entirety.

### FIELD OF THE INVENTION

The present invention relates to bags, sacks and pouches for holding a food within a cooking or heating appliance.

### SUMMARY OF THE INVENTION

Disclosed herein is a cooking bag to avoid a messy clean-up after grilling, toasting or otherwise cooking food in a grill, toaster, toaster oven or similar cooking appliance. The bag is designed to withstand the heat of cooking and is adapted to directly contact hot grilling surfaces without melting or burning during normal use.

The cooking bag is adapted to contain not only the food being cooked but also any liquids and grease which may be driven from the food during cooking. Since the food within the bag does not directly contact the cooking appliance, there is little or no need for clean-up. Moreover, the cooking bag can be produced economically so that it may be discarded after use to further eliminate any clean-up.

The cooking bag can include a bag support member for engaging a bottom surface of a clam shell type grill or flat grill. The bag support member supports the cooking bag, and the enclosed food item, on the bottom cooking surface to thereby maintain the position of the cooking bag on the bottom cooking surface. The bag support member can be utilized to prevent a sliding of the bag, and the enclosed food item along the bottom cooking surface when the bottom cooking surface is provided at an inclined position.

It is possible to form a liquid and grease compartment in the bag to separate the food being cooked from the liquid and grease which drips from the food. Alternatively, or in addition to this separate liquid and grease compartment, an absorbent material may be disposed within the bag for absorbing liquid and grease. This is advantageous in that the absorbent material prevents liquids and grease from flowing out of the bag during cooking in the cooking appliance, during removal of the bag from a cooking appliance, during removal of the cooked food from the bag, and during disposal of the bag.

The bag may be constructed from a cooking parchment having a low friction interior coating to facilitate removal of food from the bag after cooking, grilling, baking, etc. The bag is adapted to be positioned in any orientation within a cooking appliance, from vertical to horizontal. Mounting holes or other mounting arrangements can be used to secure and fix the bag in position within an appliance during cooking.

### BRIEF DESCRIPTION OF DRAWINGS

FIG. 1 is a top perspective view of a cooking bag constructed in accordance with the present invention and mounted in a vertical orientation with a cooking appliance.

FIGS. 2 through 7 are views of alternate bag constructions in accordance with the present invention.

FIG. 8 is a partial view in section of a bag constructed in accordance with the invention and including a grease trap.

FIG. 9 is an enlarged view of section 9 of FIG. 8.

FIGS. 10 and 11 are alternate constructions of section 9 of FIG. 8.

FIG. 12 is a view of a bag having a series of attachment points for forming a grease trap.

FIG. 13 is a perspective view of a bag constructed in accordance with the invention adapted for use with a horizontal or mildly inclined clamshell-type grill.

FIG. 14 is an alternate construction of bag having side holders constructed in accordance with the invention.

FIG. 15 is a schematic view of a strip of multiple bags formed from a perforated tube-like assembly.

FIG. 16 is a perspective view of a bag constructed with a bonded edge seam.

FIG. 17 is an enlarged view in section of the seam of area A in FIG. 16.

FIG. 18 is a perspective view of a bag constructed with a bonded face seam.

FIG. 19 is an enlarged view in section of the seam of area B in FIG. 19.

FIGS. 21 through 23 show further embodiments of cooking bags constructed in accordance with the present invention.

FIG. 24 is a perspective view of another embodiment of a cooking bag having a reclosable adhesive top flap and a removable side panel.

FIG. 25 is an exploded view of FIG. 24 with the peel-off strip removed and the flaps peeled open to release a side panel.

FIG. 26 is a perspective view of another embodiment of a cooking bag.

FIG. 27 is a partial cross sectional view through the seam of the bag of FIG. 26.

FIG. 28 is a partial cross sectional view through the bottom of the bag of FIG. 26.

FIG. 29 is a side view of a bag constructed in accordance with the present disclosure adapted to be supported on an inclined clamshell-type grill.

FIG. 30 depicts a bag adapted to be supported on a clam shell-type grill as shown in FIG. 29.

FIG. 31 depicts another bag adapted to be supported on a clam shell-type grill as shown in FIG. 29.

FIG. 32 depicts another bag adapted to be supported on a clamshell-type grill as shown in FIG. 29.

FIG. 33 depicts another bag adapted to be supported on a clam shell-type grill as shown in FIG. 29.

FIG. 34 depicts a cross-sectional view of another bag adapted to be supported on a clam shell-type grill as shown in FIG. 29,

FIG. 35 depicts the bag of FIG. 34 in a folded condition.

FIG. 36 depicts a sectional view a two layer material for a cooking bag of the present disclosure.

FIG. 37 depicts a sectional view a three layer material for a cooking bag of the present disclosure.

### DETAILED DESCRIPTION OF THE PREFERRED EMBODIMENTS

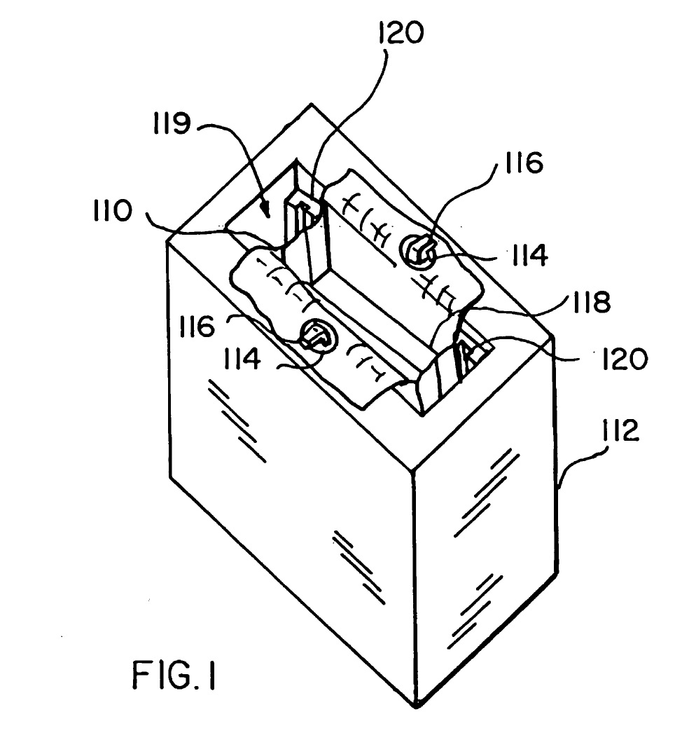

A bag 110 constructed in accordance with the invention is shown in FIG. 1 mounted to a heating or cooking appliance 112. Appliance 112 can be of virtually any construction such as a toaster, grill, oven, or the like. As depicted in FIG. 1, bag 110 is provided with such mounting holes, slits or perforations 114 that are adapted to engage mounting projections such as elbows or hooks 116 fixed to the appliance 112. The holes or slits can be less than one inch in diameter and can be anywhere from ⅛ inch long or ⅛ inch in diameter to about ½ inch long to ½ inch in diameter. It is also possible to clip or clamp the bag 110 in position by substituting or adding spring-biased clips or clamps such as those used on clipboards to the appliance 110. Alternatively, wire clips similar to paper clips, can be used for this purpose.

In this manner, the bag 110 can be vertically suspended within the cooking appliance 112 for holding a food item 118 within a cooking compartment 119 as the food is grilled, broiled, toasted, baked or otherwise cooked within the cooking appliance 112. Alternatively, the bag 110 can be mounted at any angle between horizontal and vertical. Food item 118 can be virtually any type of food such as beef, poultry, fish or vegetables. Movable opposed heated grill plates 120 can be mounted in the side walls of appliance 112 and adapted to clamp bag 110 and food item 118 between them and apply grill marks to the food item through the bag 110.

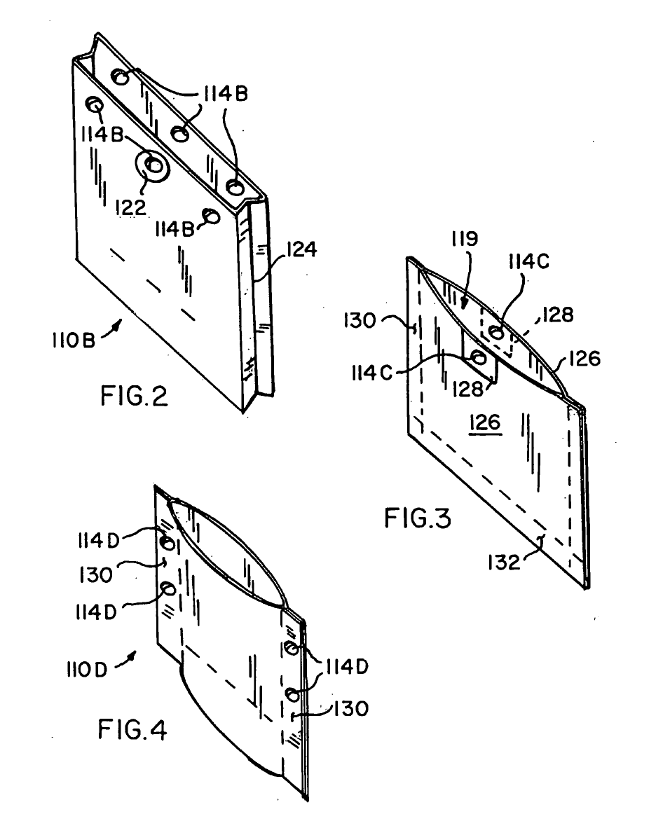

As seen in FIGS. 2 through 18, a bag according to the invention can take numerous forms and can be manufactured in many different ways. In FIG. 2, bag 110B is formed with a series of mounting holes 114B. A reinforcing ring 122 can be applied around the periphery of each mounting hole 114B to add strength to the bag 110B to prevent tearing when the bag is suspended with a food item 118 as shown in FIG. 1. Ring 122 can be formed of paper, cloth, plastic or other material, and can be circular, oval, rectangular or any other shape. Adhesive or heat can be used to bond the ring 122 to the bag 110B. Ring 122 can be applied as an adhesive bead which surrounds hole 114.

As further seen in FIG. 2, bag 110B can be formed with side folds or gussets 124 to expand in accordion fashion to accommodate thicker food items such as thick steaks or vegetables.

Alternatively, as seen in FIG. 3, an extension of each side panel 126 of bag 110C can be formed as a tab which can be folded over and glued or otherwise fixed to its respective side panel 126 so as to form a reinforcing ring 128. Each side panel 126 is glued to the opposed side panel 126 along each side edge 130 and along bottom edge 132 so as to form the internal cooking compartment 119. These edges 130 and 132 can be folded over and bonded for even greater strength. Alternatively, the edges 130 and 132 can be mechanically joined together, such as by crimping, embossing, or the use of a fastening device.

An alternate location for mounting holes 114D is shown in FIG. 4 wherein the mounting holes 114D are formed through side edges 130 of bag 110D. In this case, the cooking appliance can be provided with matching internal mounting projections.

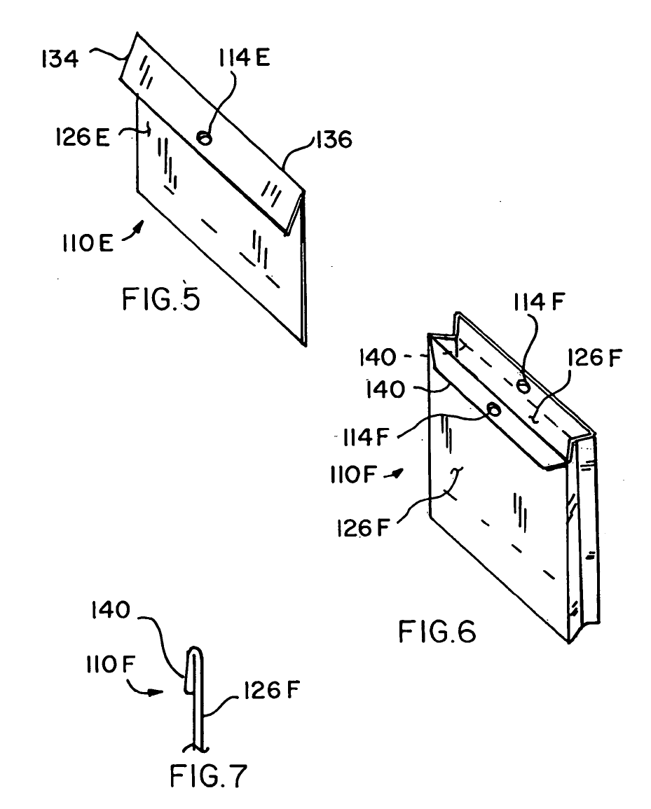

Another embodiment of bag 110E is shown in FIG. 5 wherein one side panel 126E is extended beyond the top edge of the other side panel and folded over to form a flap 134 with a preformed seam 136. Alternatively, both side panels can be folded over. A single mounting hole 114E may be provided, as shown formed in flap 134. In this manner, the bag 110E can substantially encapsulate a food item 18.

With the embodiment of FIG. 5, a food item can be prepackaged within bag 110E and refrigerated or frozen until use. Such prepackaged food items can be sold at grocery stores, brought home and cooked without any mess or preparation other than inserting the prepackaged food item into the appliance, cooking it and removing it from bag 110E and eating it. The bag 110E can be discarded, or can include a closure at the top such as the folded top edge of side panel 126E shown in FIG. 5. Alternatively, the bag 110E may be formed with a snap closure, a “zip lock”-type closure as found on sandwich bags, a mechanically seal, a heat seal, removable adhesive seal, a seal as used on freezer bags.

FIGS. 6 and 7 show an embodiment of the bag, 110F, similar to that shown in FIG. 3, except the entire top edge 140 of each side panel 126F is folded over for reinforcement and strength.

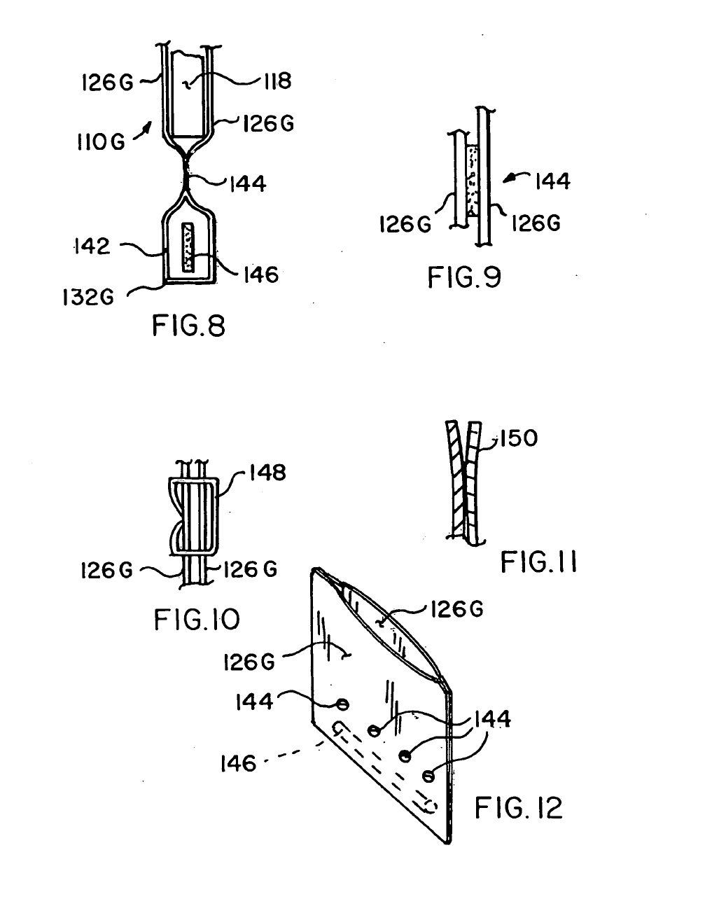

FIGS. 8 through 12 show the formation of a liquid, grease and residue trap 142 along the bottom edge 132G of bag 110G. Trap 142 can be formed by gluing laterally spaced apart bonds 144 (FIGS. 9 and 12) between the interior walls of each side panel 126G.

In this manner, food item 118 within the cooking compartment is held suspended above or spaced from the trap 142, as shown in FIG. 8. An optional absorbent strip, pad, wad 146, or the like can be disposed in trap 142 to absorb liquid and residue during cooking and subsequent handling of bag 110G so as to prevent residue and liquid from escaping trap 142.

FIG. 10 shows the use of mechanical fasteners such as staples 148 instead of spot bonds 144 and FIG. 11 shows the similar use of crimp or embossed regions or spot welds 150 in place of spot bonds 144. Crimp regions can be formed by heat and pressure and or by piercing through panels 126G.

Wad 146 can be formed of absorbent paper such as used in paper towels, or foamy or sponge-type synthetic material, or fabric and felt-type materials and cotton.

The bag, such as 110E shown in FIG. 5, can be placed on the bottom half 152 of grill 112B. The top half 154 of grill 112B is pivotally attached to the bottom half 152 by a hinge 156.

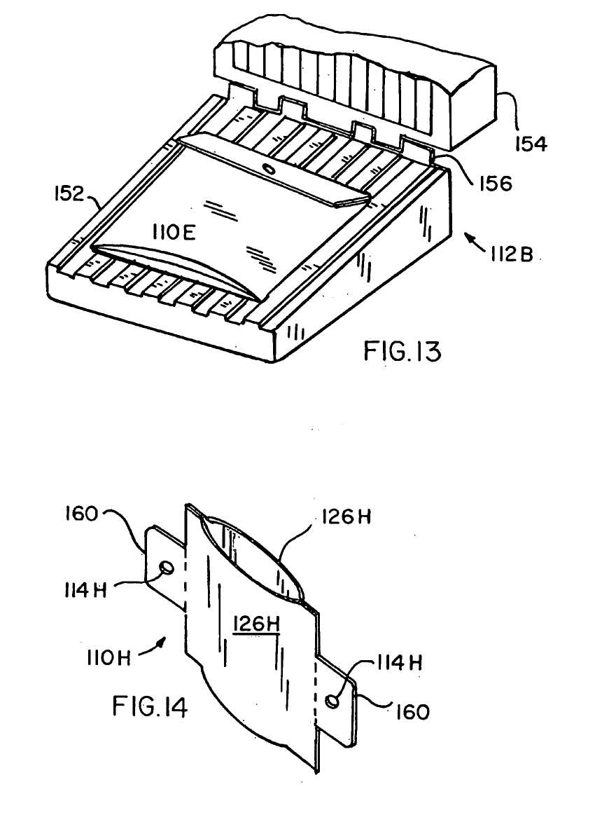

As seen in FIG. 14, side handles or grasps 160 may be formed as extensions of side panels 126H and bonded together along bond line 162. Grasps 160 help to avoid contact with the heated central portion of bag 110H. Mounting holes 114H may be formed in side grasps 60 to engage mating projections within a cooking appliance.

As seen in FIG. 15, a series of interconnected bags 110J can be formed from an elongated tube 166 in a manner similar to rolled lengths of plastic bags commonly used at grocery store produce and bagging locations. Sealed sections 132J form the bottom edge of each bag and bonds 144J define trap areas 142J and cooking compartments 119J. Transverse perforations 170 allow the individual bags 110J to be separated from tube 166 which may be formed into a roll for dispensing.

FIGS. 16 through 19 show alternate bag constructions with bonded edges. In FIGS. 16 and 17 the side edges 130K are bonded together along adhesive bond line 172K. A single panel 174K is folded over along a bottom fold line 176K prior to forming the adhesive bond lines 172K. Alternatively, the side edges 130K can be mechanically joined together, such as by crimping, embossing, or the use of a fastening device.

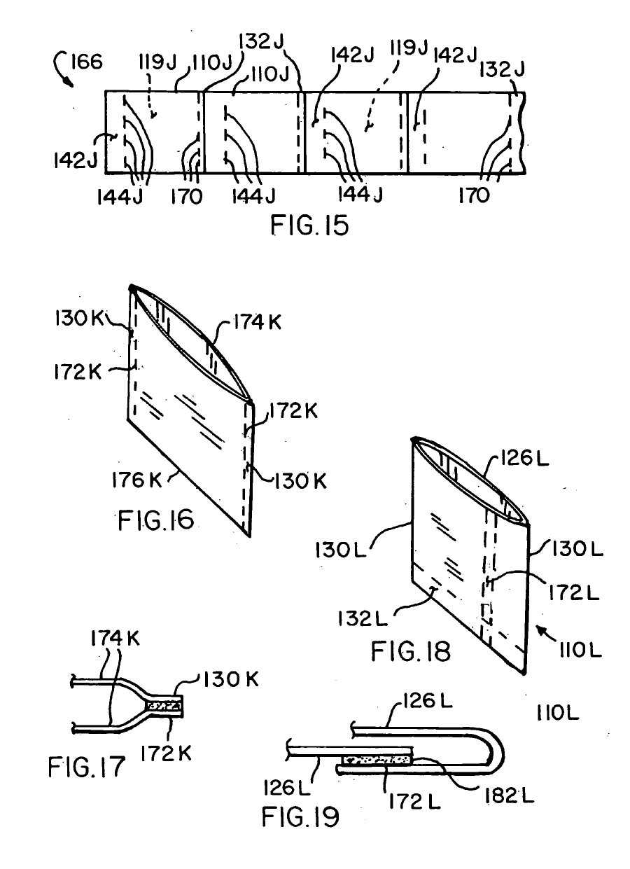

In FIGS. 18 and 19 a single vertical bond line 172L can be formed along an overlapped interior portion of the panel 126L. A single bottom weld or bond 172L may also be formed along bottom portion 132L. A silicone based food grade adhesive 182L can be used for forming bonds in bag 110L and Silidor parchment and wax paper can be used for panels 126L. Alternatively, single vertical line 172L can be formed by crimping, embossing, or the use of a fastening device. Cooking parchment with a cooking oil or other food release coating or agent can also be used for panels 126L.

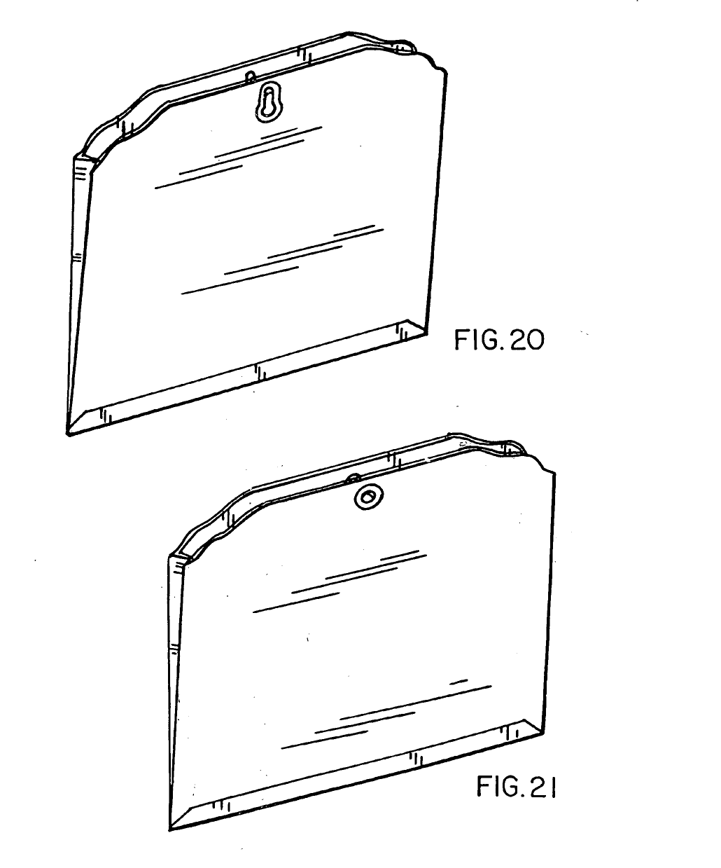

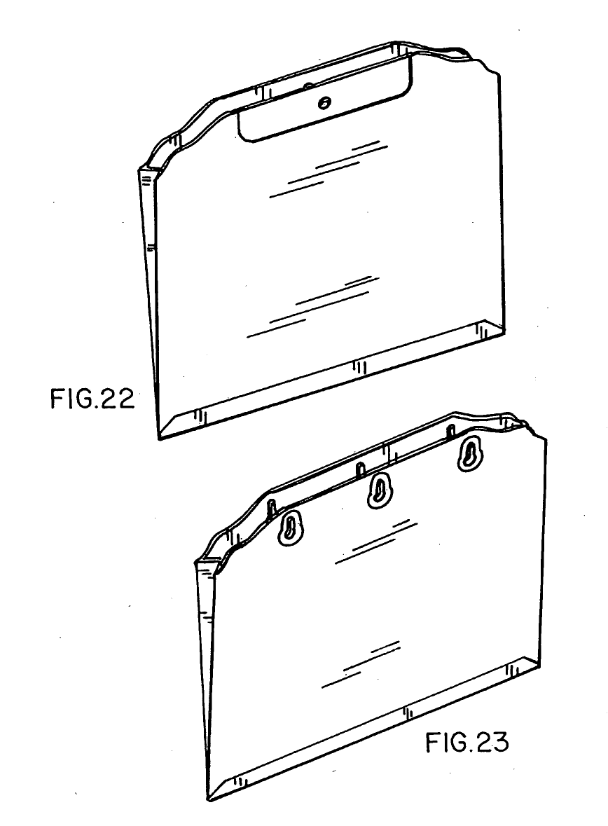

FIGS. 20, 21, 22, and 23 show further bag embodiments according to the invention.

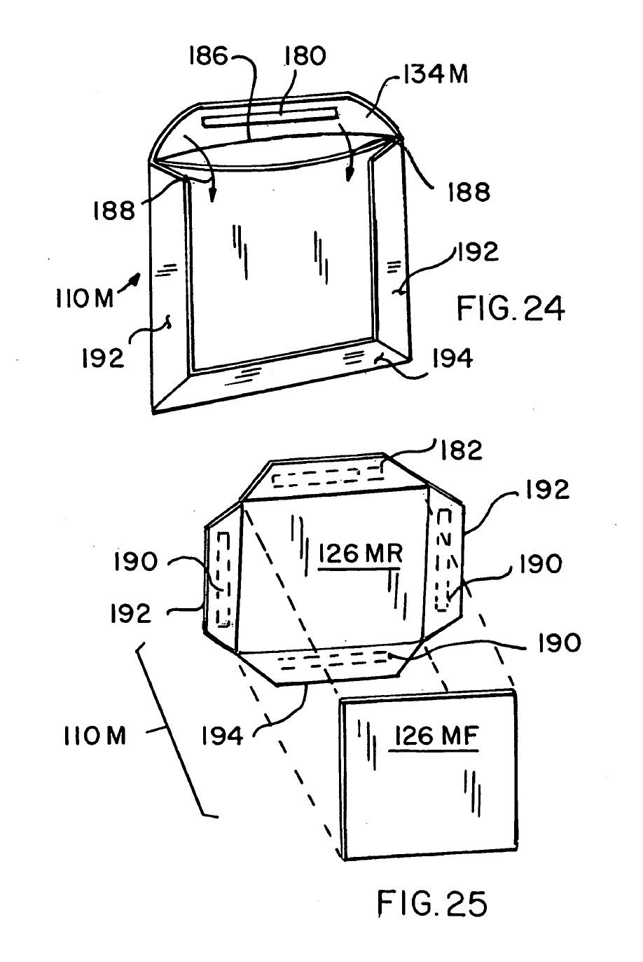

FIGS. 24 and 25 show another embodiment of the invention wherein bag 110M is provided with a closure flap 134M having a peel-off strip 180 covering a strip of tacky adhesive 182. Strip 180 may be peeled away to uncover the underlying adhesive 182. Closure flap 134 may then be folded downwardly along fold line 186 in the direction of arrows 88 to form a liquid or air-tight seal on bag 110M. Adhesive 182 may be of the gummy reusable type, allowing flap 134 to be opened and effectively resealed several times.

Similar releasable adhesive 90 (FIG. 25) may be provided on side flaps 192 and bottom flap 194 to allow these flaps to be peeled from the front side panel 126MF so as to release and remove the front side panel 126MF from the rear side panel 126MR. This allows frozen food to be easily removed, as well as heated food. The front panel 126MF may be repositioned over the rear panel 126MR and resealed by flaps 190, 194 and 134M.

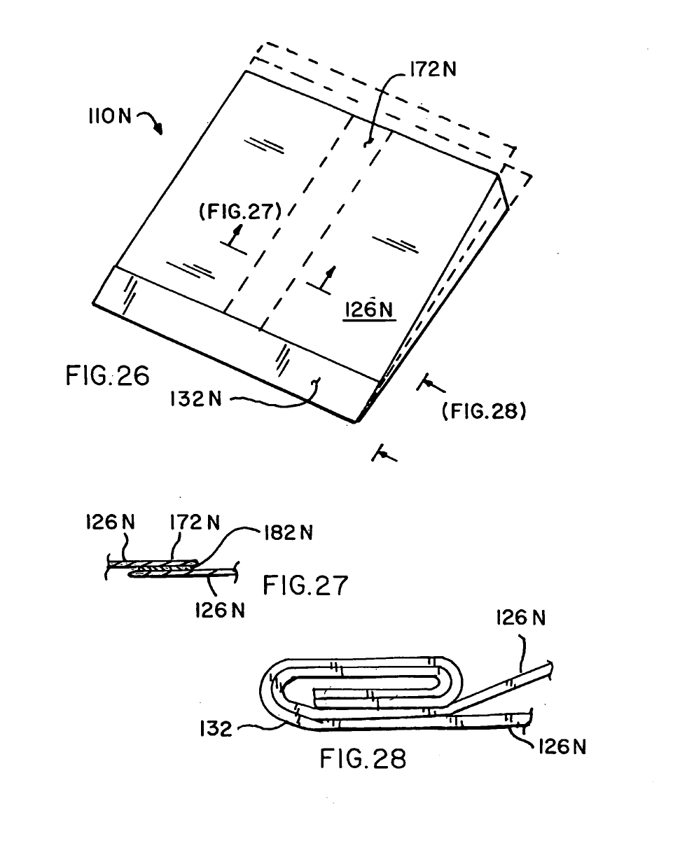

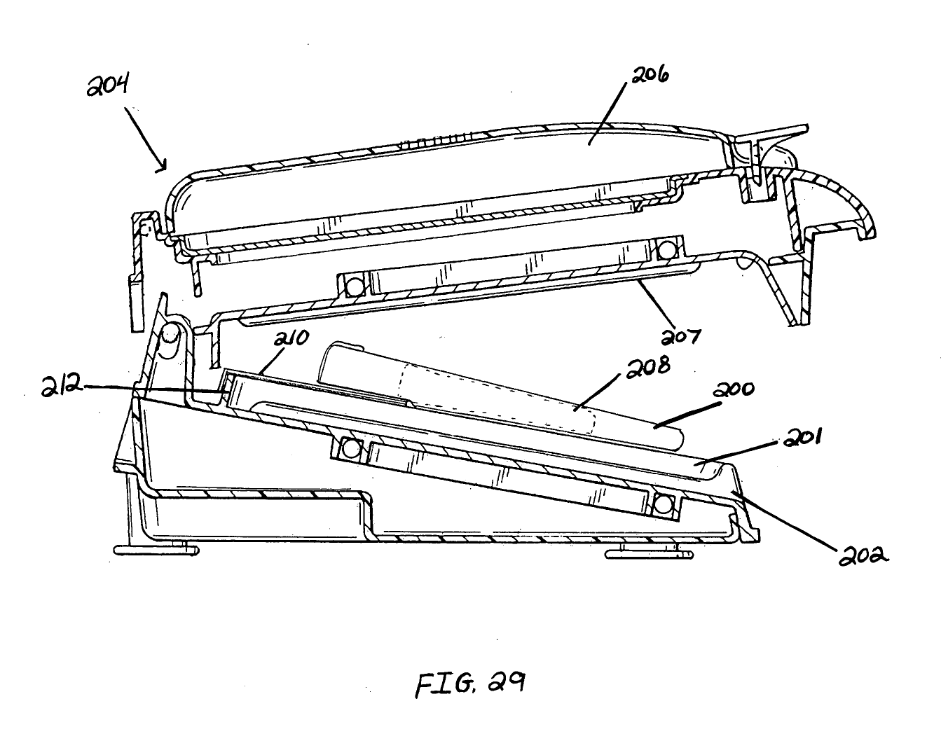

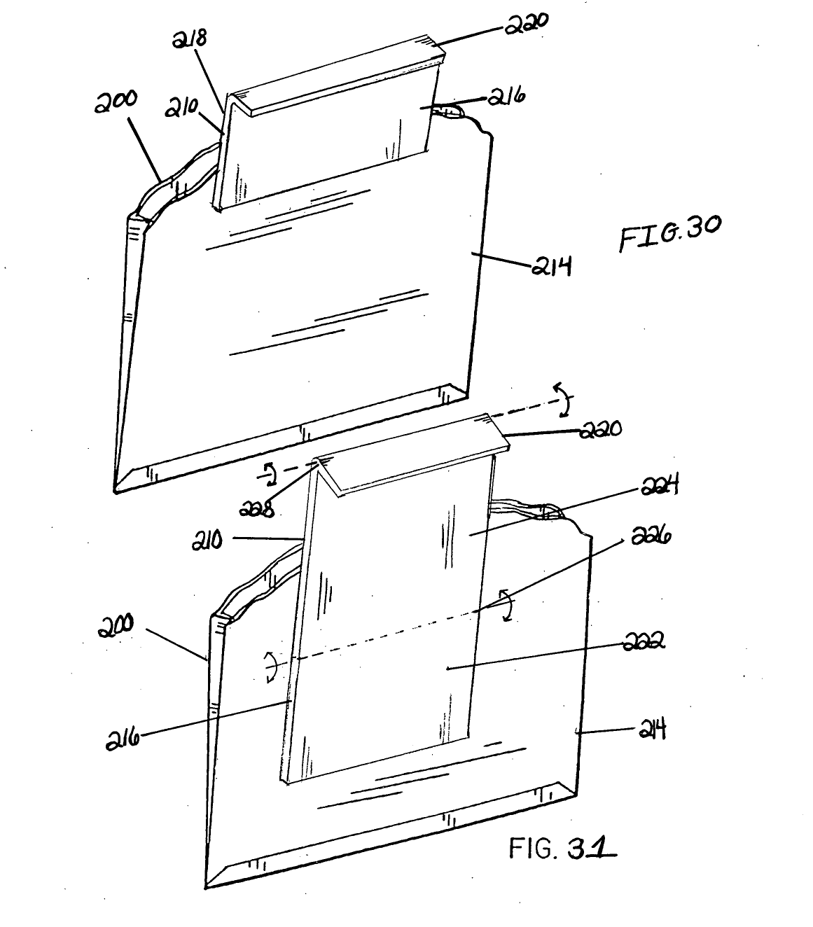

FIGS. 26 through 28 show another embodiment of the invention in the form of bag 110N, which is similar to bag 110F of FIGS. 6 and 7 except that side panel 126N is rolled upon itself to seal the bottom of the bag along its bottom edge 132N, as shown in FIG. 28. Bottom edge 132N and bond line 172N may be bonded by adhesive 182N, crimping, embossing, the use of a fastening device, or some other known means.

Referring to FIG. 29, a bag 200 of the present disclosure can be positioned on cooking surface 201 of a bottom half 202 of a clam shell type grill 204. The top half 206 of the clam shell type grill 206 is pivotally attached to the bottom half 202, such that the top half 206 can be rotated to depress the bag 200 between the top and bottom cooking surfaces 201,207 of the clam shell type grill 204. In this manner, a food product 208, positioned inside the bag 200, can be simultaneously cooked on opposite sides.

The bag 200 includes a bag support member 210 affixed thereto, where the bag support member 210 extends along and from a back surface 214 of the bag 200 to engage a lipped portion 212 of the bottom half 202 of the clam shell type grill 204. The bag support member 210 substantially maintains the position of the bag 200 on the bottom cooking surface 201 of the clam shell type grill 204, thereby substantially preventing a sliding of the bag 200 along the bottom cooking surface 201 of the clam shell type grill 204.

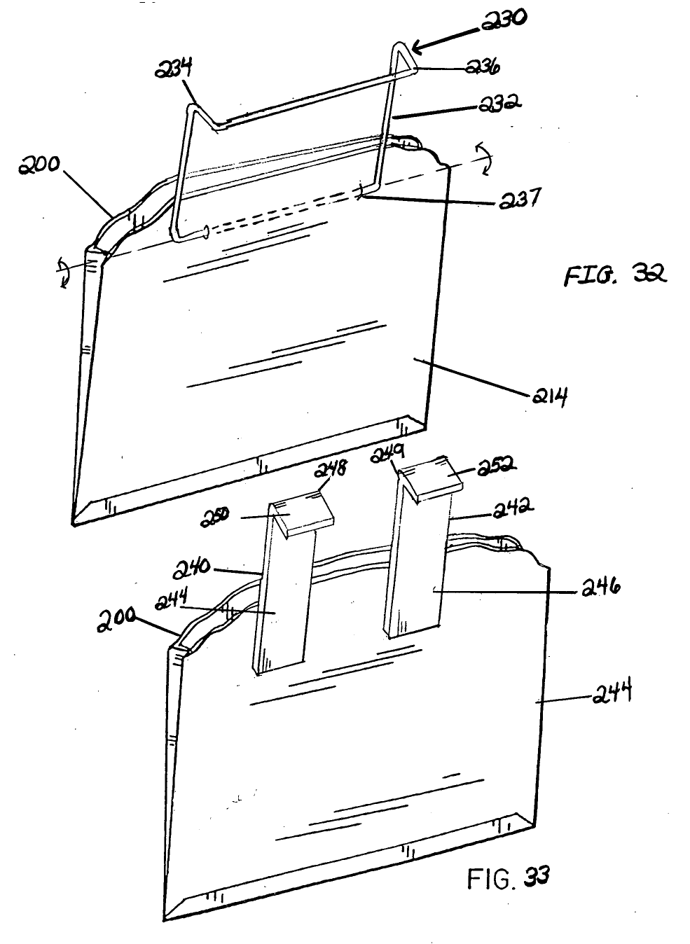

Referring to FIG. 30, the bag support member 210 is affixed to the backside surface 214 of the bag 200. The bag support member 210 includes a lower extension 216 affixed to and extending along a backside surface 214 of the bag 200. A first end 218 of the lower extension 216 includes an upper extension 220, where the upper extension 220 is positioned in an angular relation to the lower extension 216. In this manner, the upper extension 220 can engage the lipped portion 212 of the bottom half 202 of the clam shell type grill 204. The upper extension 220 can be substantially orthogonal to the lower extension 216. However, it is contemplated the other angular and geometric relationships between the upper extension 220 and the lower extension 216 may be utilized, so long as the upper extension 220 can engage the bottom half 202 of the clam shell type grill 204.

Referring to FIG. 31, the lower extension 216 of the bag support member 210 can include a first portion 222 and a second portion 224, where the second portion 224 is pivotable with respect to the first portion 222. The first portion 222 is affixed to the backside surface 214 of the bag 200, where the first and second portions 222, 224 extending long the backside surface 214 on the bag 200. The pivotal connection 226 between the first and second portions 222, 224 allows for the rotation of the second portion 224 with respect to the first portion 222. The second portion 224 can be rotated from a closed position (not shown) to an open position. In the closed position, the second portion 224 is folded down over the first portion 222, forming a more compact size and allowing for easier storage of the bag 200. In the open position, the second portion 224 is rotated into an extended position, such that the upper extension 220 can engage the bottom half 202 of the clam shell type grill 204.

The upper extension 220 extends from the second portion 224 of the lower extension 216, where the upper extension 220 can be pivotally connected to the second portion 224. The pivotal connection 228 between the upper extension 220 and the second portion 224 allows for the rotation of the upper extension 220 from a closed position to an open position. In the closed position, the upper extension 220 is folded down over the second portion 224, forming a more compact size and allowing for easier storage. In the open position, the upper extension 220 is rotated into an extended position, such that the upper extension 220 is positioned in an angular relationship with the second portion 224. In this configuration, the upper extension 200 can engage the bottom half 202 of the clam shell type grill 204, supporting the position of the bag 200 on the bottom cooking surface 201.

Referring to FIG. 32, the bag support member is in the form of a support frame 230, where the support frame 230 is affixed to the backside surface 214 of the bag 200. The support frame 230 can made from wire, plastic, cardboard, or other heat resistant materials. The support frame 230 includes a lower extension 232 affixed to and extending along a backside surface 214 of the bag 200. A first end 234 of the lower extension 216 is formed in the shape of an upper extension 236, where the upper extension 236 is in an angularly configuration with respect to the lower extension 232. In this manner, the upper extension 236 can engage the lipped portion 212 of the bottom half 202 of the clam shell type grill 204. The upper extension 236 can be substantially orthogonal to the lower extension 232. However, it is contemplated the other angular and geometric relationships between the upper extension 236 and the lower extension 232 may be utilized, so long as the upper extension 232 can engage the bottom half 202 of the clam shell type grill 204.

The lower extension 232 can be pivotally connected to the backside surface 214 of the bag 200. The pivotal connection 237 between the lower extension 232 and the bag 200 allows for the rotation of the support member 230 with respect to the backside surface 214 of the bag 200. The support member 230 can be rotated from a closed position (not shown) to an open position. In the closed position, the support member is folded down onto the backside surface 214 of the bag, forming a more compact size and allowing for easier storage of the bag 200. In the open position, the bag support member 230 is rotated into an extended position, such that the upper extension 236 can engage the bottom half 202 of the clam shell type grill 204, supporting the position of the bag 200 on the bottom cooking surface 201.

Referring to FIG. 33, the bag support member can include a first support member 240 and a second support member 242, where the first and second support members 240, 242 are affixed to a backside surface 214 of the bag 200. The bag support members 240, 242 each include a lower extension 244, 246 affixed to and extending along a backside surface 214 of the bag 200. First ends 248, 249 of the lower extensions 244, 246 include upper extensions 250, 252, where the upper extensions 250, 252 are respectively provided in an angular relationship to the lower extensions 244, 246. In this manner, the upper extensions 250, 252 can engage the lipped portion 212 of the bottom half 202 of the clam shell type grill 204. The upper extensions 250, 252 can be substantially orthogonal to the lower extensions 244, 246. However, it is contemplated the other angular and geometric relationships between the upper extensions 250, 252 and the lower extension 244, 246 may be utilized, so long as the upper extensions 250, 252 can engage the bottom half 202 of the clam shell type grill 204.

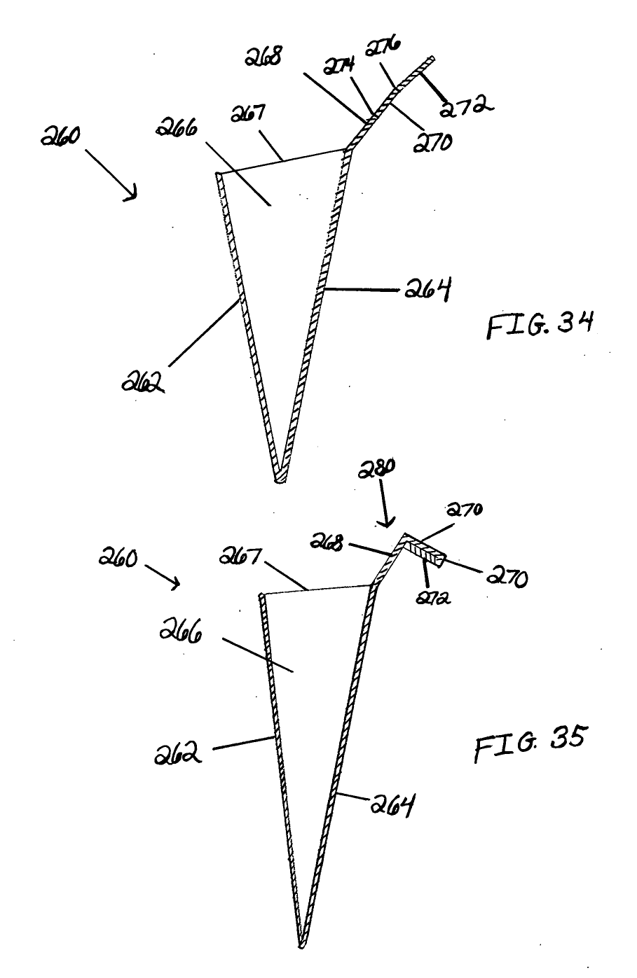

Referring to FIGS. 34 and 35, a bag 260 of the present disclosure includes a front and back surface 262, 264 formed/affixed together defining a cooking compartment 266. The back surface 264 of the bag 260 includes an extended section 268, extending the lengths of at least a portion of the back surface 264 beyond the bag opening 267. The extending section 268 has first and second upper sections 270 and 272. The upper section 270 and 272 are foldable at folding sections 274 and 276 to form an upper extension 278, where the upper extension 278 is provided in an angular relationship with the extended section 268. In this manner, the extended section 260 and upper extension 278 form a bag support member 280.

In the folded position, the first and second upper extension 270 and 274 are folded together to form the upper extension 278, such that when the bag 260 is positioned on a bottom cooking surface 201 the upper extension 278 can engage the bottom half 202 of the clam shell type grill 204, supporting the position of the bag 2260 on the bottom cooking surface 201.

The bag of the present disclose has been depict as being formed of a single of material, such as parchment, wax paper, plastic, metallic foil, and the like. It is additionally contemplated that the bag material can be absorbent.

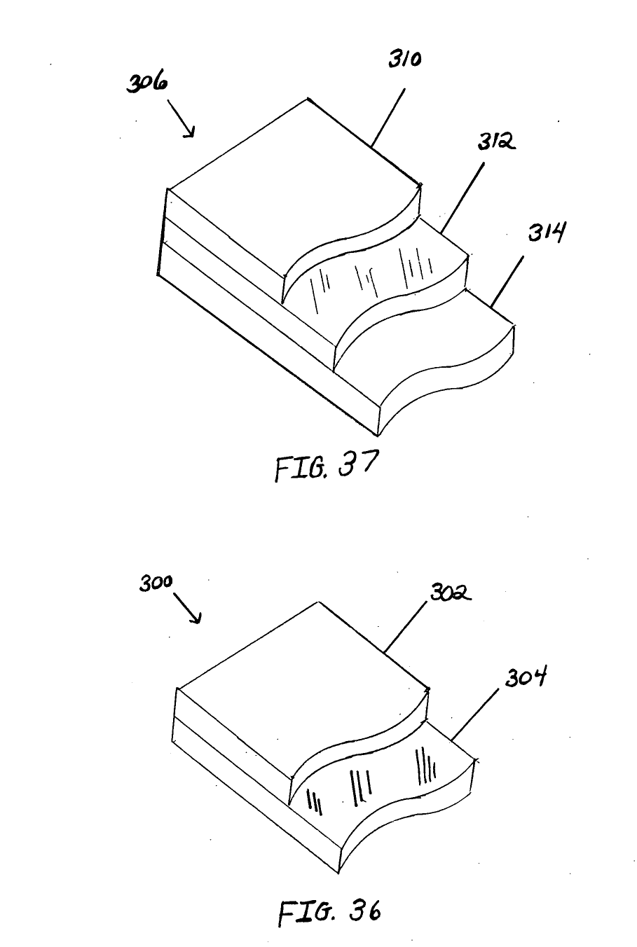

It is further contemplated that the bag material can be multilayer, including two or more layers. Referring to FIG. 36, the bag material 300 includes a first and a second layers 302 and 304. In an exemplary embodiment, the first layer 302 is an outer layer and is formed from a metallic foil. The second layer 304 is an inner layer and is formed from a fluid absorbent material. It is also contemplated that the first and second layers 302 and 304 can each be formed for parchment, wax paper, plastic, metallic foil, an absorbent material, and the like.

Referring to FIG. 37, the bag material 306 can include first, second, and third layers 310, 312, and 314. In an exemplary embodiment, the first layer 310 is an outer layer and is formed from a parchment. The third layer 314 is an inner layer and is formed from a fluid absorbent material. The second layer 312 is interposed between the first and second layer 310 and 314, can formed from a metallic foil. It is also contemplated that the first, second, and third layers 310, 312 and 314 can each be formed for parchment, wax paper, plastic, metallic foil, an absorbent material, and the like.

It will be appreciated by those skilled in the art that the above bags are merely representative of the many possible embodiments of the invention and that the scope of the invention should not be limited thereto, but instead should only be limited according to the following claims.

What is claimed:

1. A cooking bag, comprising:
a front and back surface defining a cooking compartment; and
a bag support member projecting from the back surface.

2. A cooking bag as set forth in claim 1, wherein the bag support member is formed from an extension of the back surface.

3. A cooking bag as set forth in claim 1, wherein the bag support member is affixed to the back surface.

4. A cooking bag as set forth in claim 2, wherein the bag support member is pivotally connected to the back surface.

5. A cooking bag as set forth in claim 2, where the bag support member comprises:
a lower extension affixed to the back surface of the bag; and
an upper extension provided in an angular relation to the lower extension.

6. A cooking bag as set forth in claim 1, wherein said cooking bag comprises an upper edge defining an opening and wherein bag support member extends past the upper edge.

7. A cooking bag as set forth in claim 1, wherein the opening is sealable

8. A cooking bag as set forth in claim 2, wherein the bag support member is a frame.

9. A cooking bag as set forth in claim 2, wherein the bag support member comprises first and second support members.

10. A cooking bag as set forth in claim 1, wherein the cooking bag includes a liquid and grease control system.

11. A cooking bag as set forth in claim 10, where in the liquid and grease control system includes a liquid compartment in fluid communication with the cooking compartment.

12. A cooking bag as set forth in claim 11, wherein an absorbent material is positioned in the liquid compartment.

13. A cooking bag as set forth in claim 10, wherein the liquid and grease control system includes an absorbent material provided in the cooking compartment.

14. A cooking bag as set forth in claim 1, further comprising a closure flap.

15. A cooking bag as set forth in claim 1, wherein the front and back surfaces include a plurality of layers.

16. A cooking assembly, comprising:
a cooking appliance including a top cooking half having a top cooking surface and bottom cooking half having a bottom cooking surface, wherein the top cooking half is pivotally mounted to the bottom cooking half; and
a cooking bag including a bag support member, wherein the cooking bag is positionable on the bottom cooking surface, between the top and bottom cooking surfaces, such that the bag support member engages at least a portion of the bottom cooking half.

17. A cooking assembly as set forth in claim 16, wherein the bottom cooking surface is inclined and the bag support member maintains the position of the cooking bag on the inclined bottom cooking surface.

18. A method of cooking a food item comprising:
providing a cooking bag having a bag support member;
positioning the food item in the cooking bag;
providing a cooking grill having a cooking surface;
positioning the cooking bag on the cooking surface;
engaging the cooking grill with the bag support member, wherein the bag support member maintains the position of the cooking bag on the cooking surface.

19. A method of cooking a food item as set forth in claim 18, wherein the cooking surface is inclined.
